(19) United States
(12) Patent Application Publication
(10) Pub. No.: US 2005/0016332 A1
(43) Pub. Date: Jan. 27, 2005

(54) Wrench combination

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/852,491

(22) Filed: May 24, 2004

(30) Foreign Application Priority Data
Jul. 22, 2003 (TW) 92120163

(51) Int. Cl. B25B 23/16

(52) U.S. Cl. 81/177.8

(57) ABSTRACT

A wrench combination includes a first wrench defining a circular space and a toothed face forming at a wall of the circular space. A second wrench is rotationally put in the circular space. The second wrench defines a bore and two apertures communicated with the bore. A least one claw is movably put in the apertures. The claw includes a toothed face for engagement with the toothed face of the first wrench. A switch is put in the bore for contact with the claw.

### FIELD OF INVENTION

The present invention relates to a wrench combination.

### BACKGROUND OF INVENTION

FIGS. 8 and 9 show a conventional wrench combination 3.

Referring to FIG. 8, the conventional wrench combination 3 includes a first wrench 130 and a second wrench 150. The first wrench 130 includes a handle 162 and an annular head 161 from which the handle 162 extends. The handle 162 includes a circular space 131 and a toothed face 134 formed at a wall of the circular space 131. The second wrench 150 includes a handle 132, a shaft 133 extending from the handle 132 and an annular groove 138 defined in the shaft 133. The handle 132 includes a bore 151 defined in a top, two apertures (not numbered) defined in two sides and two apertures (not numbered) defined in a bottom. The shaft 133 includes a bore 135 communicated with the bore 151, two crescent space 136 defined in two sides and two apertures (not numbered) defined in a bottom. A control device 4 includes a switch 140, two detents 141, a spring 142 and two pawls 143. The switch 140 includes a lever 402 and a ridge 401 extending from the lever 402. The lever 402 and the ridge 401 each includes an aperture (not numbered) defined therein. The pawl 143 includes a top, a bottom, a smooth end 433, a toothed end 432, a flat side, an arched side, a bore (not numbered) defined in longitudinal direction thereof and two concave grooves 431 defined in the flat side. A pin P is inserted into the bores of the handle 132 through the bore of the switch 140 so that the switch 140 is firmly attached to the handle 132. Two pins P are inserted into the bores of the handle 132 through the bores of the shaft 133 and the pawls 143 so that the pawls 143 are firmly attached to the crescent spaces 136. A C-ring 139 includes an internal edge put in the annular groove 138. The second wrench 150 is firmly attached to the first wrench 130 by means of the C-ring 139. Each of the pawls 143 includes two concave grooves 431 selective one of which receives the detent 141. Thus, the switch 140 can drive the toothed ends 432 of the pawls 143 into engagement with the toothed face 134 so as to keep the first wrench 130 and the second wrench 150 in a locked mode. Moreover, the switch 140 can drive the flat ends 433 of the pawls 143 into disengagement from the toothed face 134 so as to keep the first wrench 130 and the second wrench 150 in a rotational mode. The wrench combination 3 however includes a complicated structure and involves complicated fabrication and results in a high cost. Referring to FIG. 9, when the second wrench 150 is used to drive the first wrench 130 clockwise or counterclockwise, only one of the pawls 143 is engaged with the toothed face 134. The engagement of only one pawl 143 with the toothed face 134 is inadequate to ensure the non-rotational relation between the second wrench 150 and the first wrench 130.

The present invention is therefore intended to obviate or at least alleviate the problems encountered in prior art.

### SUMMARY OF INVENTION

The primary objective of the present invention is to provide a structurally simple wrench combination.

According to the present invention, a wrench combination includes a first wrench defining a circular space and a toothed face forming at a wall of the circular space. A second wrench is rotationally put in the circular space. The second wrench defines a bore and two apertures communicated with the bore. A least one claw is movably put in the apertures. The claw includes a toothed face for engagement with the toothed face of the first wrench. A switch is put in the bore for contact with the claw.

Other objects, advantages, and novel features of the invention will become more apparent from the following detailed description when taken in conjunction with the attached drawings.

### BRIEF DESCRIPTION OF DRAWINGS

The present invention will be described through detailed illustration of three embodiments referring to the drawings.

FIG. 1 is a perspective view of a wrench combination according to a first embodiment of the present invention.

FIG. 2 is an exploded view of the wrench combination of FIG. 1.

FIG. 3 is a cross-sectional view of the wrench combination of FIG. 1.

FIG. 4 is a cross-sectional view of the wrench combination of FIG. 1 moved to a first working mode.

FIG. 5 is similar to FIG. 4 but shows the switch moved to a second working mode.

FIG. 6 is a cross-sectional view of a wrench combination according to the second embodiment of the present invention.

FIG. 7 is a cross-sectional view of a wrench combination according to the third embodiment of the present invention.

FIG. 8 is an exploded view of a conventional wrench combination.

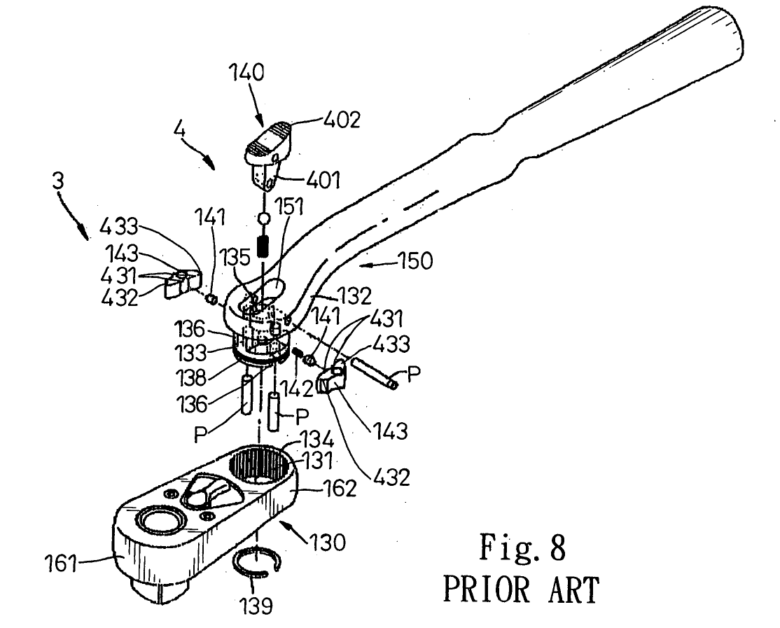

FIG. 9 is a cross-sectional view of the wrench combination shown in FIG. 8.

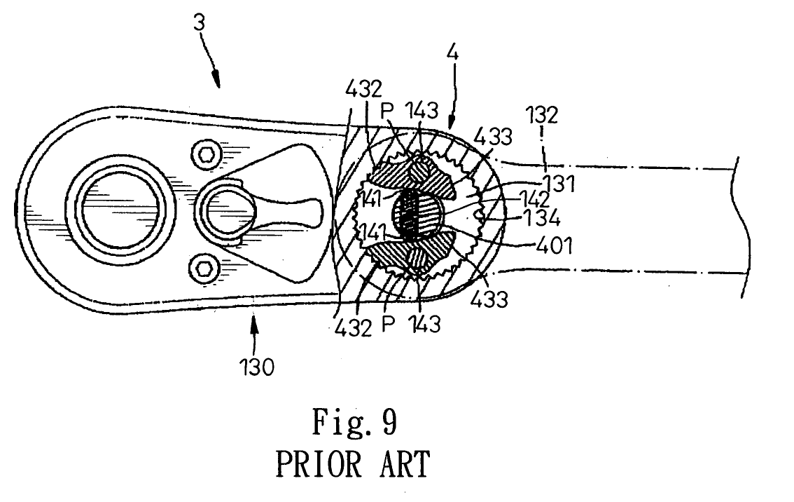

### DETAILED DESCRIPTION OF EMBODIMENTS

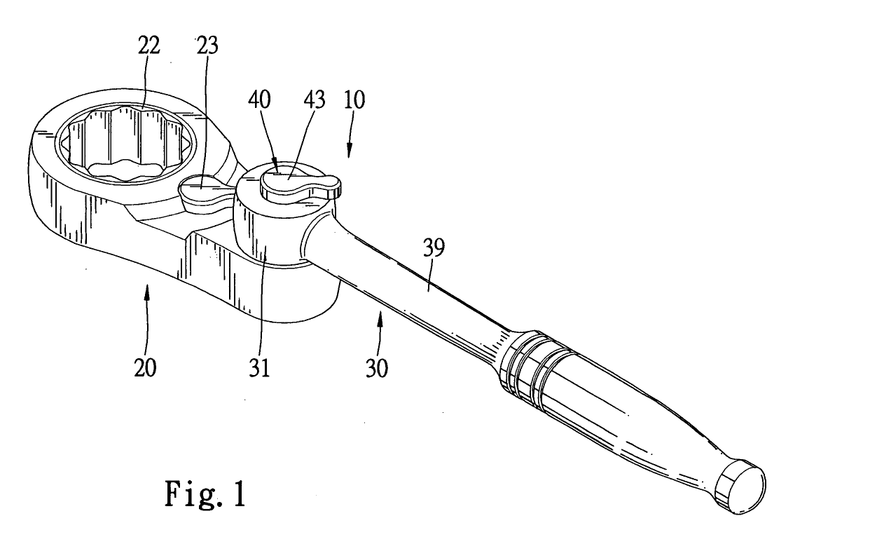

Referring to FIG. 1, according to a first embodiment of the present invention, a wrench combination 10 includes a first wrench 20 and a second wrench 30.

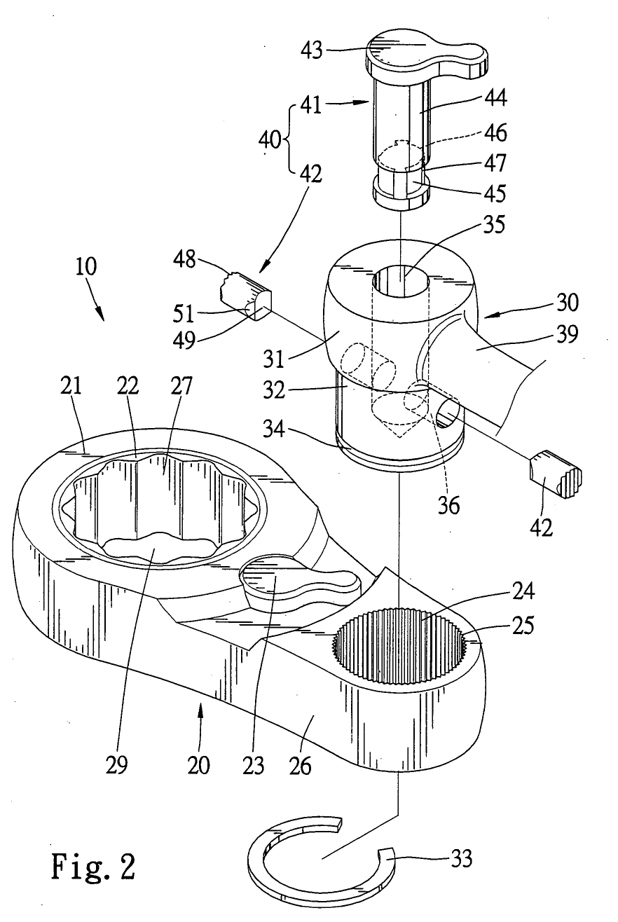

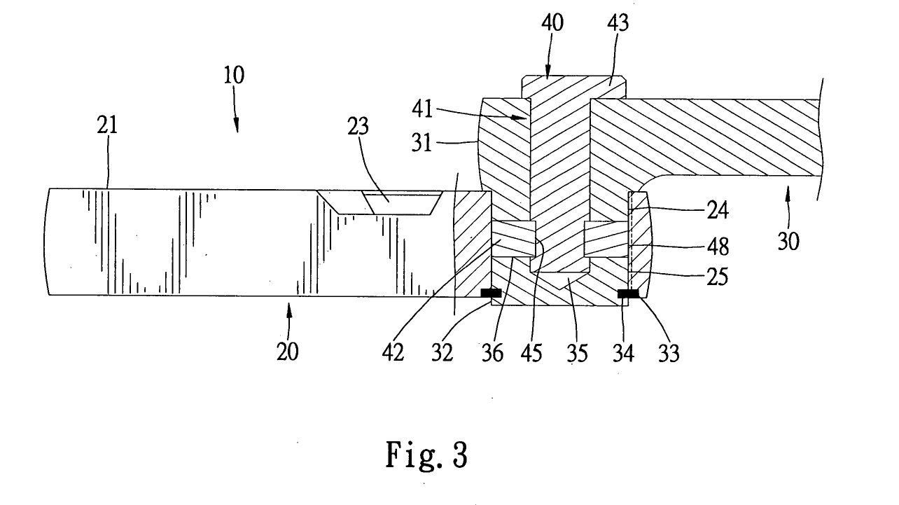

Referring to FIGS. 2 and 3, the first wrench 20 includes a handle 26 and an annular head 21 from which the handle 26 extends. The annular head 21 defines a circular space 29 for receiving an annular gear 22. The annular gear 22 includes a toothed internal face 27 for engagement with a bolt or nut. A switch 23 is put in the annular head 21. How the switch 41 cooperates with the annular gear 22 will not be described in detail for being conventional. The handle 26 defines a circular space 24, a toothed face 25 formed at a wall of the circular space 24.

The second wrench 30 includes a head 31, a handle 39 extending from the head 31, a shaft 32 extending from the head 31 and an annular groove 34 defined in the shaft 32. A bore 35 extends throughout the head 31 and the shaft 32. The shaft 32 includes two apertures 36 communicated with the bore 35.

A control device 40 includes a switch 41 and two claws 42. The switch 41 is put in the bore 35 of the second wrench 30. The switch 41 includes a lever 43, a shaft 44 extending from the lever 43, two first cambered faces 45 and two second cambered faces 46 forming on the shaft 44. The first cambered faces 45 are closer to an axis of the shaft 44 than the second cambered faces 46 so that a radial face 47 is formed between each first cambered face 45 and one second cambered face 46.

The claws 42 are movably put in the apertures 36. The claw 42 includes a toothed face 48 formed at an end thereof and a concave face 49 formed at the other end thereof. The claw 42 includes two inclined faces 51 extending from the concave face 49.

A C-ring 33 includes an internal edge put in the annular groove 34. The second wrench 30 is firmly attached to the first wrench 20 by means of the C-ring 33.

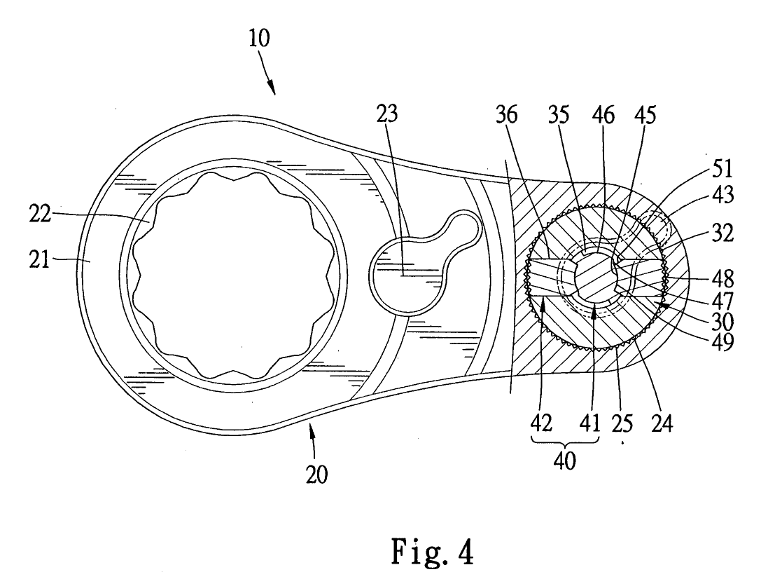

FIG. 4 shows the switch 41 in a rotational mode. The concave faces 49 abut the first cambered faces 45. The claws 42 can extend into the first cambered faces 45. Therefore, the toothed faces 48 disengage from the toothed face 25 so as to keep the first wrench 20 and the second wrench 30 in the rotational mode.

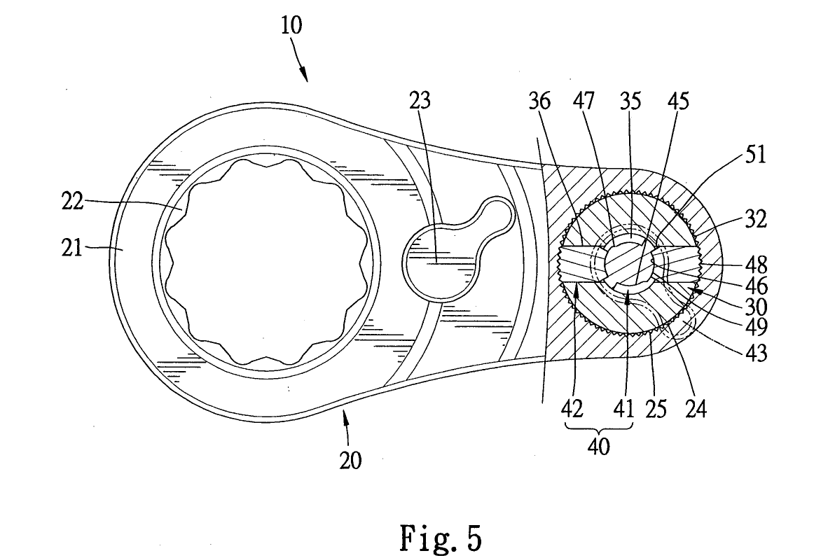

FIG. 5 shows the switch 41 moved to a locked mode. The concave faces 49 abut the second cambered faces 46. The claws 42 can be moved outwardly from the second cambered faces 46. Therefore, the toothed faces 48 engage with the toothed face 25 so as to keep the first wrench 20 and the second wrench 30 in the locked mode.

The concave faces 49 can move smoothly between the first cambered faces 45 and the second cambered faces 46 by means of the radial faces 47 and the inclined faces 51. Furthermore, the concave faces 49 are firmly engaged with the second cambered faces 46 by means of the faces of the second cambered faces 46 and the concave faces 49 so that the force of engagement is improved between the toothed face 25 and the toothed faces 48. Therefore, when the wrench combination 10 is in the locked mode, no matter the second wrench 30 is rotational clockwise or counterclockwise relative to the first wrench 20, both of the claws 42 lock the first wrench 20 and the second wrench 30 together. Thus, it is extremely difficult, if not impossible, to rotate the second wrench 30 relative to the first wrench 20.

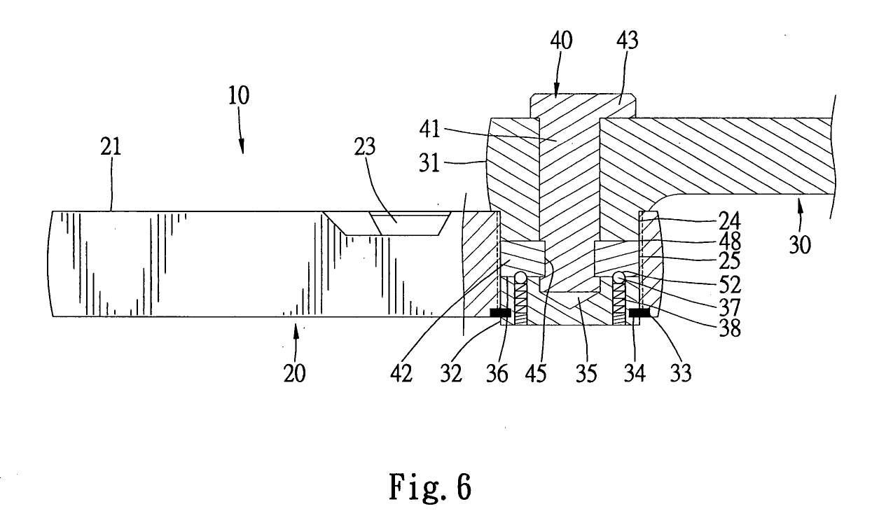

FIG. 6 shows a wrench combination 10 according to a second embodiment of the present invention. The second embodiment is identical to the first embodiment except that the second wrench 30 includes two ball detents 37 and two springs 38. Each claw 42 defines a recess 52 for receiving the detent 37 so as to keep the claws 42 in position relative to the detents 37.

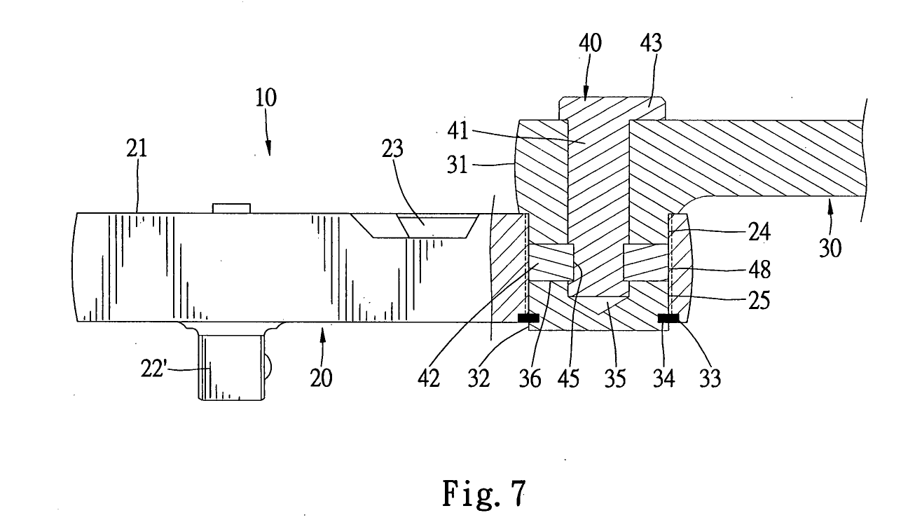

FIG. 7 shows a wrench combination 10 according to a third embodiment of the present invention. The third embodiment is identical to the first embodiment except that the annular gear 22 includes a square insert 22′ for insertion in and rotation of a socket.

The present invention has been described through detailed illustration of three embodiments. Those skilled in the art can derive variation from the embodiments without departing from the scope of the present invention. Therefore, the embodiments shall not limit the scope of the present invention defined in the claims.

1. A wrench combination comprising:
a first wrench defining a circular space and a toothed face forming at a wall of the circular space;
a second wrench rotationally put in the circular space, the second wrench defining a bore and two apertures communicated with the bore;
at least one claw movably put in the apertures, the claw comprising a toothed face for engagement with the toothed face of the first wrench; and
a switch for contact with the claw in the bore.

2. The wrench combination according to claim 1 wherein the switch comprises a lever operable for the rotation thereof.

3. The wrench combination according to claim 1 wherein the switch comprises a shaft extending into the bore for contact with the claw.

4. The wrench combination according to claim 3 wherein the claw comprising a concave face, wherein the shaft comprises two first cambered face and two second cambered face for contact with the concave face of the claw so that the switch can switch the second wrench between a locked mode and a rotational mode with the first wrench.

5. The wrench combination according to claim 3 wherein the shaft comprises two radial faces each extending between related one of the first cambered faces and related one of the second cambered faces.

6. The wrench combination according to claim 5 wherein the claw comprises two inclined faces extending from the concave face so that the claw can move smoothly between the first cambered faces and the second cambered faces by means of the inclined faces sliding on the radial faces.

7. The wrench combination according to claim 1 wherein the first wrench comprises an annular head and a handle extending from the head.

8. The wrench combination according to claim 1 including an annular gear put in the annular head.

9. The wrench combination according to claim 8 wherein the annular gear comprises an insert for insertion in a socket.

10. The wrench combination according to claim 1 including a C-ring, wherein the second wrench defines an annular groove in an external side for receiving an internal edge of the C-ring.

11. The wrench combination according to claim 1 including two detents, wherein the claw defines one recess for receiving related one of the detents so as to keep the claw in position relative to the detents.

12. The wrench combination according to claim 11 wherein the detents are spring-biased detents.
